(19) United States
(12) Patent Application Publication
(10) Pub. No.: US 2006/0067805 A1
(43) Pub. Date: Mar. 30, 2006

(54) Crimped nail

(76) Inventor: Richard W. Reed, Rockford, IL (US)

Correspondence Address: KEITH FRANTZ, 401 WEST STATE STREET, SUITE 200, ROCKFORD, IL, 61101, US

(21) Appl. No.: 10/951,580

(22) Filed: Sep. 29, 2004

(51) Int. Cl. F16B 15/00

(52) U.S. Cl. 411/451.2

(57) ABSTRACT

A nail for temporarily securing articles to a concrete structure includes a double-head and an elongated shank with a lower end crimped on opposite sides to establish offset undulating profiles. The nail is driven into a hole in the concrete, with conventional nail installation tools, to establish a snug yet relatively light interference fit. The nail is removed from the concrete, with conventional clawed nail removal tools, when the need for the temporary installation is complete.

CROSS-REFERENCES TO RELATED APPLICATIONS

None.

Reference To Sequence Listing, Table, Or Computer Program Listing Appendix Submitted On A Compact Disc

Not Applicable.

STATEMENT REGARDING FEDERALLY SPONSORED RESEARCH OR DEVELOPMENT

Not Applicable.

### BACKGROUND OF THE INVENTION

1. Field of Invention

The present invention relates generally to nails.

More particularly, the invention relates to a crimped nail that is especially suitable for temporary installation into concrete and other masonry structures, for temporarily anchoring or securing articles to such structures, and to a method associated therewith.

2. Description of Prior Art

During construction of a building, and certain other construction activities, there is sometimes a need to temporarily secure an article to a concrete structure. For example, a wall form may be temporarily secured to a concrete footing to enable pouring a concrete wall on top of the footing. Other articles are temporarily secured to concrete structures for various purposes at the convenience of the builder.

A common technique used in the construction industry to temporarily secure an article to concrete is to drill a hole in the concrete sized to snugly receive a nail and a pair of small diameter wires. The wires are slipped into the hole, and then the nail is driven into the hole with the wires. The snug fit caused by both the wires and the nail in the hole is fairly light to enable removal of the nail when desired, but is sufficient to retain the nail in position either alone or while securing an article to the concrete. The nail and wires are removed from the hole when the temporary anchoring is no longer needed. However, this common technique for temporarily securing articles to concrete suffers from several drawbacks and disadvantages. The tradesman must maintain a ready supply of both nails and wires in complimentary diameters and lengths. Use of wires with the nails involves additional time and results in additional cost to the job. Cautionary measures must be taken to prevent pre-cut lengths of wires from inadvertent damage or sever bending prior to use. The wires may need to be separately held in place as the nail is driven into position, and the wires must be separately removed from the hole after the nail is removed. Separate positioning of the wires can be particularly troublesome when anchoring to a slanted or overhead concrete structure.

Numerous fasteners are designed to deform under high compression when installed, and/or to bite into concrete to serve as permanent anchors. Some of these anchors utilize a sleeve or other arrangement to achieve a high compression fit in a hole, while others are designed to fit tightly without the need for wires or sleeves. However, such anchors are generally not designed for ease removal, most of which are intentionally designed to prevent removal. Of those capable of being removed, they are not suitable for quick, temporary anchoring purposes due to the difficulty in removing the fasteners from a high compression or biting fit in the concrete.

### SUMMARY OF THE INVENTION

The general objective of the present invention is to provide a new and unique crimped nail suitable for quick, temporary installation into and ease of removal from concrete, without the need for wires or any other additional components, thereby eliminating the above-identified disadvantages and drawbacks of the conventional technique of using both wires and nails.

Another objective of the invention is to provide a new and unique method for temporarily anchoring to concrete without the need for wires or additional components.

These and other objectives and advantages of the invention will become more apparent from the following detailed description when taken in conjunction with the accompanying drawings.

A preferred embodiment nail in accordance with the invention includes a double-head and a shank with a lower end crimped on opposite sides to establish offset undulating profiles. The nail is driven into a hole in the concrete sized for a snug yet relatively light interference fit. The nail is temporary installed in the concrete by simply hammering the nail into the hole. The nail can also be installed into other masonry like base structures. The nail is easily removed with a conventional clawed tool when the need for the temporary installation is finished.

### BRIEF DESCRIPTION OF THE DRAWINGS

FIG. 1 is a view illustrating a PRIOR ART arrangement, including a front view of a nail and a pair of wires, for temporarily anchoring to a concrete structure shown in fragmentary cross-section.

FIG. 2 is a fragmentary cross-sectional view of the nail and wires shown in FIG. 1 as may be installed into the concrete structure for anchoring thereto.

FIG. 3 is a fragmentary cross-sectional view of the nail and wires shown in FIG. 1 securing an article to the concrete structure.

FIG. 4 is a front view of a nail incorporating the unique aspects of the present invention.

FIG. 5 is a side view of the nail shown in FIG. 4, the nail being shown rotated ninety degrees from the view in FIG. 4.

FIG. 6 is a bottom end view of the nail shown in FIGS. 4-5.

FIG. 7 is a cross-sectional view of the nail as taken along the line 7-7 of FIG. 4.

FIG. 8 is a fragmentary cross-sectional view of the nail shown in FIGS. 4-7 as installed into the concrete structure.

FIG. 9 is a fragmentary cross-sectional view showing nails in accordance with the invention temporarily securing blocks to the concrete structure, the blocks securing a concrete form onto the top of the concrete structure.

While the invention is susceptible of various modifications and alternative constructions, certain illustrated embodiments have been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF THE INVENTION

The present invention relates to a nail for temporary installation into a concrete structure, for temporarily securing articles in fixed relation to the structure. A nail in accordance with the invention eliminates the need for wires used in prior techniques to temporarily secure articles to concrete structures.

As used herein, the term concrete is intended to include other masonry and masonry-like structures. Although a concrete footing is shown in the drawings and discussed in further detail below, it will be understood that nails in accordance with the invention are equally suitable for use in, and may offer certain additional advantages when used in vertical structures, slanted structures and overhead structures. As the invention is described and claimed herein, directional modifiers such as upper, lower, upwardly downwardly, above, below, etc. are used for correspondence with the several views in the drawings. However, it will be understood that such modifiers are for convenience only, and nails in accordance with the invention can be used in any orientation.

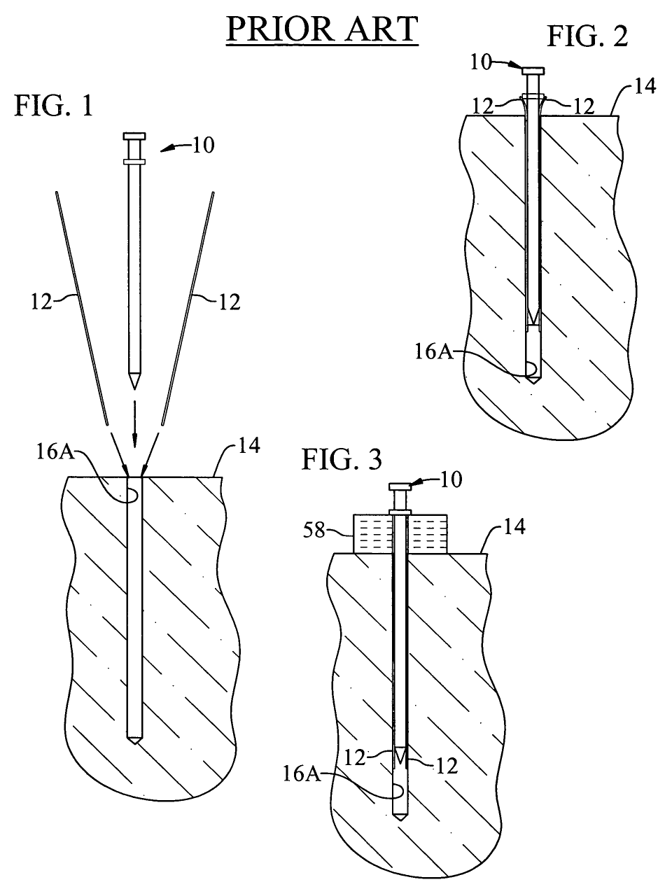

One prior technique used in the construction industry to temporarily secure an article to concrete is illustrated in FIGS. 1-3. FIG. 1 shows a fragmentary cross-section of a concrete footing 14, a conventional, straight shank construction grade double-headed nail 10 and a pair of wires 12. Initially, a hole 16A sized to snugly receive both the nail and the wires is drilled into the footing. As indicated with arrows in FIG. 1, the wires are slipped into the hole, and the nail is then installed into the hole with the wires in place. The snug fit of both the wires and the nail in the hole retains the nail in position either alone as illustrated in FIG. 2 such that an article can be secured to the head of the nail, or while securing an article such as block 58 shown in FIG. 3 to the footing. The nail and wires are removed from the hole in a reverse process when the anchoring function is no longer needed.

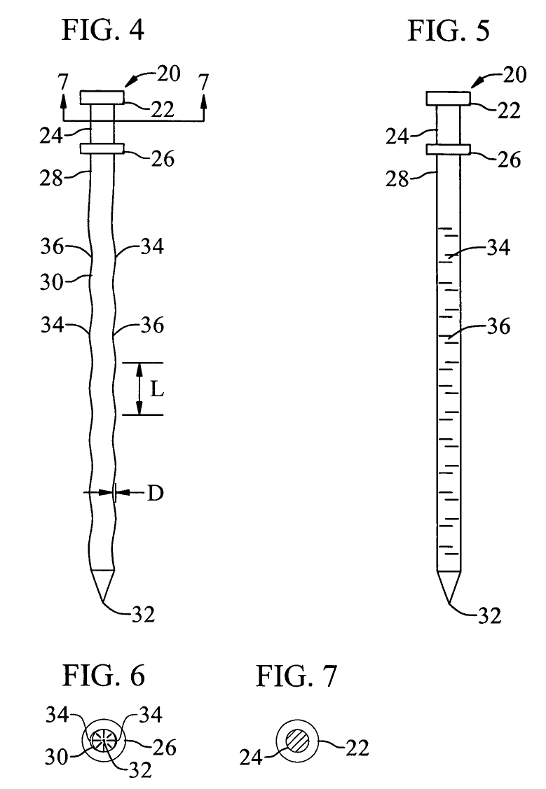

A preferred nail 20 in accordance with the invention is shown in detail in FIGS. 4-7. The nail 20 is a double-headed nail, with an upper head 22, a lower head or shoulder 26, and a head-shank 24 therebetween. The lower shoulder 26 is circular in cross-section perpendicular to the longitudinal axis of the nail (as shown in FIG. 6), and is sized in diameter larger than the shank 30 to engage the structure into which the nail is driven or secured. The upper head 22 is also circular in cross-section perpendicular to the longitudinal axis of the nail (as shown in FIG. 7), and is sized for ease of driving the nail into the footing or other structure, and for ease of removal of the nail from the structure with a clawed tool (e.g., claw hammer or pry bar). The diameter or the head-shank 24 (see e.g., FIG. 7) is smaller than the diameter of the upper head and the lower shoulder, generally of the same diameter as the shank 30, and is sized with the length (establishing the clearance between the upper head and the lower shoulder) to be received into and allow use of a clawed tool (e.g., claw hammer or pry bar) engaging under the upper head for removal of the nail from the structure. The center elongated shank 30 of the nail is also circular in cross-section as shown in FIG. 6. The center shank transitions as indicated at 28 from the shoulder 26 and terminates at an opposite free end tip 32.

The shank 30 of the nail 20 is crimped, or otherwise formed with a wavy profile when viewed from one side as shown in FIG. 4. This undulating profile is characterized with smoothly rounded peaks 34 and alternating valleys 36 spaced lengthwise along one side of the nail, with a similar but lengthwise offset profile on the opposite side of the nail. The undulating profile is crimped, stamped or otherwise formed onto a conventional-type (non-hardened) nail, simultaneously on opposite sides, such as with similarly formed dies or press jigs or other crimping devices utilizing oppositely directed pressure onto the nail, and resulting in the profile shown in FIG. 3, such that the rotated view of the nail as shown in FIG. 4 retains the substantially straight profile of a conventional nail.

As compared with permanent anchors that utilize a three-dimensional spiral in the shank, crimping a conventional nail in two dimensions provides for enhanced ease of manufacturing, and achieves a relatively inexpensive temporary anchoring nail. As compared with other permanent anchors that utilize rings or barbs or ridges encircling portions of the shank to achieve a high compression fit when installed, the two-dimensional crimped profile more easily enables a less snug fit for temporary installation and relative ease of removal. The undulating profile need not be formed along the entire length of the nail shank, but is formed along a sufficient lower length which, when combined with the fit in the hole, will establish a relatively light, yet sufficiently snug fit for temporary use.

The nail 20 is provided in sizes for snug installation into and ease of removal from a concrete structure. The preferred nail is provided between approximately two to four inches long, or at sizes between 6 d (six penny) and 20 d (twenty penny), but may be provided as up to 5 to 6 inch long (30 d-60 d) nails. The nail is further provided with an undulating profile to establish a distance “L” between peaks of between approximately one-fourth (¼) inch for smaller nails, to approximately one (1) inch for the larger nails, with, for example, a distance between peaks of approximately one-half (½) to three-fourths (¾) inch for 20 d (4 inch) nails. The peaks are sized to establish an offset “D” from the valley or root of the wave form of approximately one-thirtyseconths ( 1/32) to one-eight (⅛) inch, with, for example, an offset of between one-sixteenth ( 1/16) to three-thirtyseconths ( 3/32) for 20 d nails. The combined dimensional characteristics of the peak offset and the size of the hole into which the nail is installed will establish a light yet snug interference fit of approximately one-thirtyseconths ( 1/32) for a 20 d nail (less for smaller nails, and up to one-sixteenth ( 1/16) for the largest nails), for the crimped nail to be temporarily wedged into, and such that the concrete surrounding the hole will not under go substantial crumbling and the wavy shank of the nail will not experience substantial deformation when installed. With, for example, a 20 d nail, drilling a hole of with a conventional masonry three-sixteenths ( 3/16) inch diameter bit provides a sung fit into which the nail with a profile as characterized above can be installed for temporary anchoring purposes hereof, and a conventional five-thirtyseconths ( 5/32) bit can be used to drill a suitable hole for a 16 d nail with less crimp.

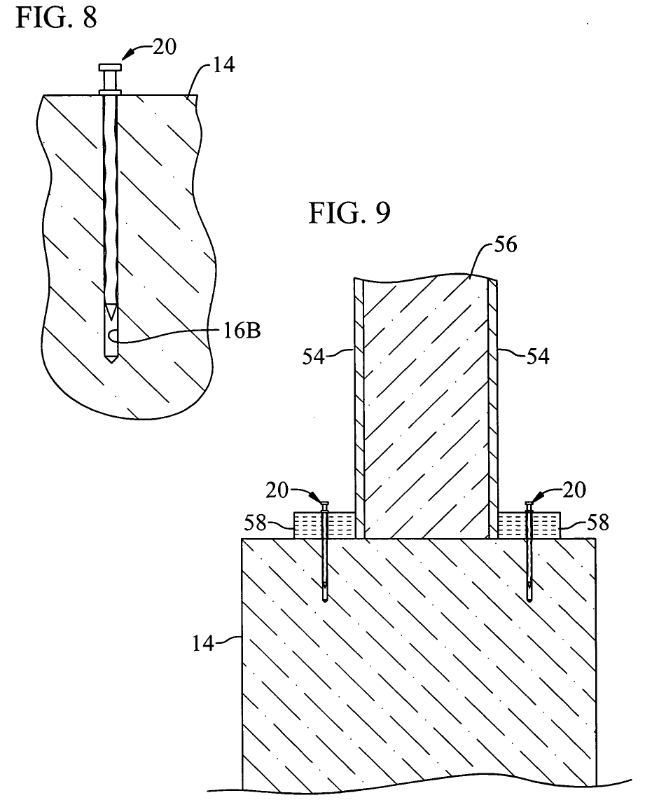

Referring to FIG. 8, the nail 20 is shown installed into a hole 16B in the concrete footing 14. To obtain the desired anchoring with the nail, the hole is drilled into the concrete as discussed above, and the nail inserted and hammered into position in the hole. If a block or other article is to be secured directly to the concrete with the nail, the nail is simply hammered through the block prior to entering the pre-drilled hole in the concrete. By comparing FIG. 2 showing the prior art technique of driving a nail into a hole with a pair of loose wires, it will be readily understood that simply driving a crimped nail in accordance with the invention will result in enhanced ease of installation and removal of the nail, and its temporary anchoring capabilities, along with a corresponding time and effort savings for the tradesman.

A specific example of use one of the nail 20 is shown in FIG. 9. In this instance, a pair of ledger blocks 58 are secured to the concrete footing 14 with a pair of nails 20. The nails are simply hammered through the blocks and into the concrete footing. When installed onto the footing, the ledger blocks secure a form 54 for a concrete wall, such as a Simon brand form, in an upright position to the footing. The concrete wall 56 is poured into the secured form. After the wall is set, the nails are easily pulled from the footing, and the ledger blocks and form are removed, leaving the concrete wall in position on top of the footing.

As those skilled in the art will readily recognize from the disclosure hereof, crimped nails in accordance with the invention can be installed into and used with masonry base structures of various compositions, and for other purposes where it is desirable to establish or temporarily secure an article either to or in fixed relation to a structure.

Accordingly, a method for temporarily securing articles to a concrete structure will include providing a construction grade nail as described above, simultaneously crimping the nail on opposite sides to establish offset undulating profiles on the lower portion of the shank, drilling a hole in the concrete, driving the nail into the hole to establish a light interference fit, securing the article to the concrete either as the nail is driven in or to the nail after secured in the concrete, and removing the nail with a clawed tool when the need for temporarily secured article has been completed.

From the foregoing, it will be apparent that the present invention brings to the art a unique nail and method for quickly and easily, temporarily securing articles to concrete and other masonry structures using ordinary tools, and without the need for additional wires or other components.

1-7. (canceled)

8. A method for temporarily securing an article to a masonry structure, the method comprising:
a) providing a construction grade nail with a central longitudinal axis, the nail having a head portion and an elongated shank,
i) the head portion having an upper head, a lower shoulder spaced below the upper head, and a head-shank extending co-axially between the upper head and the lower shoulder,
a) the upper head having an upwardly facing surface to enable driving the nail downwardly, and a circular cross-section with an outer diameter perpendicular to the longitudinal axis and co-axial therewith,
b) the lower shoulder having a downwardly facing surface, and a circular cross-section with an outer diameter perpendicular to the longitudinal axis and co-axial therewith,
c) the head-shank having an outer diameter that is smaller than the outer diameters of the upper head and the lower shoulder; and
ii) the shank having upper and lower portions and extending generally co-axially and downwardly from the lower shoulder to a terminating lower free end tip, the shank further having a circular cross-section with an outer diameter perpendicular to the longitudinal axis and smaller in diameter than the outer diameter of the lower shoulder;
b) crimping the lower portion of the shank to establish offset undulating profiles with rounded peaks and valleys on opposite sides of the shank;
c) drilling a hole in the structure, the hole being sized to establish a light interference fit with the undulating profile on the shank of the nail;
d) driving the nail into the hole;
e) securing an article to the structure either as the nail is driven into the hole or to the nail after driven into the hole in the structure; and
f) removing the nail with a clawed tool engaging the upper head when the need for temporarily secured article has been completed.

9. The method for temporarily securing an article to a base structure as defined in claim 7 in which the nail is provided having a size between 6 d and 60 d.

10. The method as defined in claim 9 in which the nail is provided having a size between 8 d and 20 d.

11. The method as defined in claim 8 in which said crimping includes forming said offset undulating profiles with rounded peaks and alternating valleys, with the peaks spaced between approximately one-fourth (¼) to one (1) inch apart.

12. The method as defined in claim 11 in which said crimping includes forming said offset undulating profiles with rounded peaks and alternating valleys, with the peaks spaced between approximately one-half (½) inch to three-fourths (¾) inch apart.

13. The method as defined in claim 8 in which said crimping includes simultaneously forming said offset undulating profiles by two-dimensional crimping onto a straight shank.

14. The method as defined in claim 8 in which the hole is sized for an interference fit with the undulating profiles of between approximately one-thirtyseconths ( 1/32) inch.

15. The method as defined in claim 8 in which the peaks are offset by approximately one-thirtyseconths ( 1/32) to one-eight (⅛) inch.

16. (canceled)

17. An elongated nail for temporarily securing articles to a masonry structure, the nail comprising:
a) a double-head having an upper head with a generally circular cross-section when viewed from above, a lower shoulder spaced below the upper head and having a generally circular cross-section co-axial therewith, and a head-shank extending between the upper head and the lower shoulder, the head-shank having a generally circular cross-section co-axial with but smaller in diameter than the upper head;
b) a lower pointed end; and
c) an elongated shank extending generally co-axially from the lower shoulder and terminating at the pointed end, the shank having a generally circular cross-section smaller in diameter than the lower shoulder, and offset undulating profiles formed on opposite sides thereof, the undulating profiles being established with smoothly rounded peaks and alternating valleys.

18. The nail as defined in claim 17 in which the offset undulating profiles are formed in said shank sized to correspond to a nail of between 6 d and 60 d.

19. The nail as defined in claim 18 in which the offset undulating profiles are formed in said shank sized to correspond to a nail of between 8 d and 20 d.

20. The nail as defined in claim 17 in which at least one of the offset undulating profiles is formed with at least two peaks spaced between approximately one-fourth (¼) inch to one (1) inch apart.

21. The nail as defined in claim 20 in which said at least two peaks are spaced between approximately one-half (½) inch to three-fourths (¾) inch apart.

22. The nail as defined in claim 17 in which the peaks of the undulating profiles are offset from adjacent valleys by between approximately one-thirtyseconths ( 1/32) inch to one-eight (⅛) inch.

23. The nail as defined in claim 17 in which the offset undulating profiles are established two-dimensionally on the shank.

24. An elongated nail for temporarily securing articles to a masonry structure, the nail comprising:
a) a double-head with an upper head, a lower shoulder and a head-shank extending therebetween; the head-shank being smaller in cross-section than the upper head when viewed from above;
b) a lower pointed end; and
c) an elongated shank extending from the lower shoulder to the pointed end; the shank having offset undulating profiles formed on opposite sides thereof, the undulating profiles being established with smoothly rounded peaks and alternating valleys.

25. The nail as defined in claim 32 in which the undulating profiles are formed two-dimensionally on the shank whereby the shank is substantially straight when viewed orthogonally with respect to said opposite sides.
